(19) United States
(12) Patent Application Publication
(10) Pub. No.: US 2026/0298856 A1
(43) Pub. Date: Oct. 1, 2026

(54) 3D IN SITU IONIC CONDUCTIVITY MEASUREMENT METHOD FOR BIAXIALLY STRETCHED POLYMER FILM COUPLED WITH ELECTROCHEMICAL IMPEDANCE SPECTROSCOPY

(71) Applicant: University of Houston, Houston, TX (US)

(72) Inventors: Haleh ARDEBILI, Sugarland, TX (US); Zaffar IQBAL, Houston, TX (US); Prashan DE MEL, Friendswood, TX (US); Taylor KELLY, San Antonio, TX (US)

(21) Appl. No.: 19/635,066

(22) Filed: Mar. 31, 2026

Related U.S. Application Data
(60) Provisional application No. 63/781,002, filed on Mar. 31, 2025.

(51) Int. Cl. G01N 27/04; G01N 19/00

(52) U.S. Cl. CPC G01N 27/041; G01N 19/00; G01N 2203/0017; G01N 2203/0244; G01N 2203/0254; G01N 2203/0617

(57) ABSTRACT

A dynamic apparatus for the in-situ measurement of a polymeric film during biaxial stretching. The dynamic apparatus includes gripping means for gripping and stretching the polymeric film in a first planar direction; gripping means for gripping and stretching the polymeric film in a second planar direction; and an electrochemical impedance spectroscopic system (EIS) for measuring ionic conductivity of the polymeric film in both in-plane and out-of-plane directions. Also provided is a dynamic method for the in-situ measurement of a polymeric film during biaxial stretching. The dynamic method includes gripping the polymeric film in a first planar direction; gripping the polymeric film in a second planar direction; stretching the polymeric film in a first planar direction; stretching the polymeric film in a second planar direction; and measuring ionic conductivity of the polymeric film in both an in-plane direction and an out-of-plane direction using an EIS system.

### RELATED APPLICATION

This application claims priority to U.S. Provisional Patent Application No. 63/781,002, filed on Mar. 31, 2025, the entire content of which is incorporated herein by reference.

### STATEMENT OF GOVERNMENT INTEREST

This invention was made with government support under Grant Award No.: NSF CAREER: CMMI-1254477, awarded by the National Science Foundation. The government has certain rights in the invention.

### FIELD

The present disclosure relates to a measurement method for use with biaxial stretched polymer films. More particularly, the present disclosure relates to a strain dependent ionic conductivity measurement method for polymer films through an in-situ out-of-plane and in-plane electrochemical impedance spectroscopy (EIS) coupled with biaxial stretching.

### BACKGROUND

Progress in the field of flexible electronics and mobile technology necessitates the corresponding developments in energy storage technology and sensors. In practice conventional energy storage devices and sensors suffer from substantial strain deformations which compels to develop flexible energy storage devices. At present there is no commercially available measurement apparatus that can measure the in-situ EIS coupled with simultaneous and sequential biaxial stretching. This disclosure will be helpful in determining the electrochemical and mechanical coupling effects on ionic conductivity.

Polymer films play a crucial role in the development of flexible energy storage devices (e.g., batteries, supercapacitors, fuel cells and sensors). These films are engineered to have mechanical properties that allow them to bend and deform without affecting structural integrity. In some situations, these mechanical deformations may cause a change in the ionic conductivity, having a substantial impact on electrochemical performance.

Therefore, what is needed is an improved and cost-effective measurement method for use with biaxial stretched polymer films.

### SUMMARY

This disclosure relates to conductivity measurements, particularly for energy storage devices. Specifically, the measurement of ionic conductivity of biaxially stretched polymer films is provided.

The current disclosure provides an in-situ 3D measurement method for EIS integrated with biaxial stretching (out-of-plane and in-plane impedance setups coupled with biaxial stretching) for measuring the ionic conductivity of polymer films.

In one aspect, provided is a dynamic apparatus for the in-situ EIS measurement of a polymeric film during biaxial stretching. The apparatus includes gripping means for gripping and stretching the polymeric film in a first planar (y) direction, gripping means for gripping and stretching the polymeric film in a second planar (x) direction, and an electrochemical impedance spectroscopic (EIS) system for measuring ionic conductivity of the polymeric film in both in-plane (x-y) and out-of-plane directions.

In some embodiments, the dynamic apparatus includes a first motor for stretching the polymeric film in the first planar (y) direction.

In some embodiments, the dynamic apparatus includes a second motor for stretching the polymeric film in the second planar (x) direction.

In some embodiments, the first motor and the second motor are each computer controlled.

In some embodiments, the dynamic apparatus includes a back horizontal supporting rod, the back horizontal supporting rod affixed to a back vertical supporting rod and a first blocking electrode located at the back of the (x-y) plane.

In some embodiments, the dynamic apparatus includes a front horizontal supporting rod, the front horizontal supporting rod secured to a front vertical supporting rod and a second blocking electrode wherein the front vertical supporting rod faces the back vertical supporting rod across the polymer film to enable out-of-plane in situ EIS measurements.

In some embodiments, the dynamic apparatus includes a first bolt for securing the front horizontal supporting rod to the front vertical supporting rod and the second blocking electrode and the back horizontal supporting rod, and a back vertical supporting rod and the first blocking electrode.

In some embodiments, the dynamic apparatus includes a second bolt for securing the front horizontal supporting rod and the back horizontal supporting rod with the back vertical member.

In some embodiments, the dynamic apparatus includes a first connector for connecting the first blocking electrode to the EIS system.

In some embodiments, the dynamic apparatus includes a second connector for connecting the second blocking electrode to the EIS system and measuring the ionic conductivity of the polymeric film in both in-plane (x-y) and out-of-plane directions.

In some embodiments, the first blocking electrode has a first surface area, and the second blocking electrode has a second surface area, wherein the first and second surface areas are substantially equal.

In some embodiments, the dynamic apparatus includes a pressure sensor to monitor surface pressure between the first and second blocking electrodes while taking EIS measurements.

In some embodiments, the pressure sensor is a piezo film pressure sensor or a torque-controlled screw.

In another aspect, provided is a dynamic method for the in-situ EIS measurement of a polymeric film during biaxial stretching. The method includes gripping the polymeric film in a first planar (x) direction, gripping the polymeric film in a second planar (y) direction, stretching the polymeric film in a first planar (x) direction, stretching the polymeric film in a second planar (y) direction; and measuring ionic conductivity of the polymeric film in both an in-plane (x-y) direction and an out-of-plane direction using an electrochemical impedance spectroscopic (EIS) system.

In some embodiments, the dynamic method includes the step of stretching the polymeric film in the first planar (x) direction with a first motor.

In some embodiments, the dynamic includes the step of stretching the polymeric film in the second planar (y) direction with a second motor.

In some embodiments, the dynamic method includes the step of controlling the first motor and the second motor via a computer.

In some embodiments, the dynamic method includes the step of affixing a back horizontal supporting rod to a back vertical supporting rod and a first blocking electrode located at the back of the (x-y) plane.

In some embodiments, the dynamic method includes the step of affixing a front horizontal supporting rod to a front vertical supporting rod and a second blocking electrode wherein the front vertical supporting rod faces the back vertical supporting rod across the polymer film to enable out-of-plane in situ EIS measurements.

In some embodiments, the dynamic method includes the step of securing with a first bolt the front horizontal supporting rod to the front vertical supporting rod and the second blocking electrode and the back horizontal supporting rod, and a back vertical supporting rod and the first blocking electrode.

In some embodiments, the dynamic method includes the step of securing with a second bolt the front horizontal supporting rod and the back horizontal supporting rod with the back vertical member.

In some embodiments, the dynamic method includes the step of connecting the first blocking electrode to the EIS system using a first connector.

In some embodiments, the dynamic method includes the step of connecting the second blocking electrode to the EIS system using a second connector and measuring the ionic conductivity of the polymeric film in both in-plane (x-y) and out-of-plane directions.

### BRIEF DESCRIPTION OF THE DRAWINGS

While the present disclosure is susceptible to various modifications and alternative forms, specific exemplary implementations thereof have been shown in the drawings and are herein described in detail. It should be understood, however, that the description herein of specific exemplary implementations is not intended to limit the disclosure to the particular forms disclosed herein. This disclosure covers all modifications and equivalents as defined by the appended claims. It should also be understood that the drawings are not necessarily to scale, emphasis instead being placed upon clearly illustrating principles of exemplary embodiments of the present disclosure. Moreover, certain dimensions may be exaggerated to help visually convey such principles. Further, where considered appropriate, reference numerals may be repeated among the drawings to indicate corresponding or analogous elements. The following drawings are provided, wherein:

FIG. 1A is a prospective view of proposed disclosure showing the approach for 3D in situ simultaneous biaxial stretching integrated with out-of-plane EIS measurement set up for stretchable polymer films and 1B shows a zoomed-out view of out-of-plane EIS set up, in accordance with an embodiment of the present disclosure.

FIG. 2A is a prospective view showing the approach for 3D in-situ simultaneous biaxial stretching integrated with an in-plane EIS measurement set up for stretchable polymer films, in accordance with an embodiment of the present disclosure.

FIG. 2B presents an enlarged view of in-plane EIS set up, in accordance with an embodiment of the present disclosure.

FIG. 3A presents a combined sectional view of simultaneous biaxial stretching. In this figure, 3A illustrates the clamping position, in accordance with an embodiment of the present disclosure.

FIG. 3B depicts the polymer film in a simultaneously biaxially stretched condition, in accordance with an embodiment of the present disclosure.

FIG. 4A presents a combined sectional view of sequential biaxial stretching. As shown, FIG. 4A illustrates the clamping position, in accordance with an embodiment of the present disclosure.

FIG. 4B shows the vertically stretched condition and horizontal clamping position, in accordance with an embodiment of the present disclosure.

FIG. 4C shows the polymer film in a sequentially stretched vertical and horizontal condition according to an embodiment of the present disclosure.

### DETAILED DESCRIPTION

### Terminology

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

A/an: The articles “a” and “an” as used herein mean one or more when applied to any feature in embodiments and implementations of the present invention described in the specification and claims. The use of “a” and “an” does not limit the meaning to a single feature unless such a limit is specifically stated. The term “a” or “an” entity refers to one or more of that entity. As such, the terms “a” (or “an”), “one or more” and “at least one” can be used interchangeably herein.

About: As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussion below regarding ranges and numerical data.

Above/below: In the following description of the representative embodiments of the invention, directional terms, such as “above”, “below”, “upper”, “lower”, etc., are used for convenience in referring to the accompanying drawings. In general, “above”, “upper”, “upward” and similar terms refer to a direction toward the earth's surface along a wellbore, and “below”, “lower”, “downward” and similar terms refer to a direction away from the earth's surface along the wellbore. Continuing with the example of relative directions in a wellbore, “upper” and “lower” may also refer to relative positions along the longitudinal dimension of a wellbore rather than relative to the surface, such as in describing both vertical and horizontal wells.

And/or: The term “and/or” placed between a first entity and a second entity means one of (1) the first entity, (2) the second entity, and (3) the first entity and the second entity. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements). As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either” “one of,” “only one of,” or “exactly one of”.

Any: The adjective “any” means one, some, or all indiscriminately of whatever quantity.

At least: As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements). The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Based on: “Based on” does not mean “based only on”, unless expressly specified otherwise. In other words, the phrase “based on” describes both “based only on,” “based at least on,” and “based at least in part on.”

Comprising: In the claims, as well as in the specification, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Couple: Any use of any form of the terms “connect”, “engage”, “couple”, “attach”, or any other term describing an interaction between elements is not meant to limit the interaction to direct interaction between the elements and may also include indirect interaction between the elements described.

Determining: “Determining” encompasses a wide variety of actions and therefore “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

Embodiments: Reference throughout the specification to “one embodiment,” “an embodiment,” “some embodiments,” “one aspect,” “an aspect,” “some aspects,” “some implementations,” “one implementation,” “an implementation,” or similar construction means that a particular component, feature, structure, method, or characteristic described in connection with the embodiment, aspect, or implementation is included in at least one embodiment and/or implementation of the claimed subject matter. Thus, the appearance of the phrases “in one embodiment” or “in an embodiment” or “in some embodiments” (or “aspects” or “implementations”) in various places throughout the specification are not necessarily all referring to the same embodiment and/or implementation. Furthermore, the particular features, structures, methods, or characteristics may be combined in any suitable manner in one or more embodiments or implementations.

Exemplary: “Exemplary” is used exclusively herein to mean “serving as an example, instance, or illustration.” Any embodiment described herein as “exemplary” is not necessarily to be construed as preferred or advantageous over other embodiments.

Flow diagram: Exemplary methods may be better appreciated with reference to flow diagrams or flow charts. While for purposes of simplicity of explanation, the illustrated methods are shown and described as a series of blocks, it is to be appreciated that the methods are not limited by the order of the blocks, as in different embodiments some blocks may occur in different orders and/or concurrently with other blocks from that shown and described. Moreover, less than all the illustrated blocks may be required to implement an exemplary method. In some examples, blocks may be combined, may be separated into multiple components, may employ additional blocks, and so on. In some examples, blocks may be implemented in logic. In other examples, processing blocks may represent functions and/or actions performed by functionally equivalent circuits (e.g., an analog circuit, a digital signal processor circuit, an application specific integrated circuit (ASIC)), or other logic device. Blocks may represent executable instructions that cause a computer, processor, and/or logic device to respond, to perform an action(s), to change states, and/or to make decisions. While the figures illustrate various actions occurring in serial, it is to be appreciated that in some examples various actions could occur concurrently, substantially in series, and/or at substantially different points in time. In some examples, methods may be implemented as processor executable instructions. Thus, a machine-readable medium may store executable processor instructions that if executed by a machine (e.g., processor) cause the machine to perform a method.

May: Note that the word “may” is used throughout this application in a permissive sense (i.e., having the potential to, being able to), not a mandatory sense (i.e., must).

Operatively connected and/or coupled: Operatively connected and/or coupled means directly or indirectly connected for transmitting or conducting information, force, energy, or matter.

Optimizing: The terms “optimal,” “optimizing,” “optimize,” “optimality,” “optimization” (as well as derivatives and other forms of those terms and linguistically related words and phrases), as used herein, are not intended to be limiting in the sense of requiring the present disclosure to find the best solution or to make the best decision. Although a mathematically optimal solution may in fact arrive at the best of all mathematically available possibilities, real-world embodiments of optimization routines, methods, models, and processes may work towards such a goal without ever actually achieving perfection. Accordingly, one of ordinary skill in the art having benefit of the present disclosure will appreciate that these terms, in the context of the scope of the present disclosure, are more general. The terms may describe one or more of: 1) working towards a solution which may be the best available solution, a preferred solution, or a solution that offers a specific benefit within a range of constraints; 2) continually improving; 3) refining; 4) searching for a high point or a maximum for an objective; 5) processing to reduce a penalty function; 6) seeking to maximize one or more factors in light of competing and/or cooperative interests in maximizing, minimizing, or otherwise controlling one or more other factors, etc.

Order of steps: It should also be understood that, unless clearly indicated to the contrary, in any methods claimed herein that include more than one step or act, the order of the steps or acts of the method is not necessarily limited to the order in which the steps or acts of the method are recited.

Ranges: Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a range of about 1 to about 200 should be interpreted to include not only the explicitly recited limits of 1 and about 200, but also to include individual sizes such as 2, 3, 4, etc. and sub-ranges such as 10 to 50, 20 to 100, etc. Similarly, it should be understood that when numerical ranges are provided, such ranges are to be construed as providing literal support for claim limitations that only recite the lower value of the range as well as claims limitation that only recite the upper value of the range. For example, a disclosed numerical range of 10 to 100 provides literal support for a claim reciting “greater than 10” (with no upper bounds) and a claim reciting “less than 100” (with no lower bounds).

As used herein, the term “sensor” includes any electrical sensing device or gauge. The sensor may be capable of monitoring or detecting pressure, temperature, displacement, vibration, resistivity, or other data. Alternatively, the sensor may be a position sensor.

### DESCRIPTION

Specific forms will now be described further by way of example. While the following examples demonstrate certain forms of the subject matter disclosed herein, they are not to be interpreted as limiting the scope thereof, but rather as contributing to a complete description.

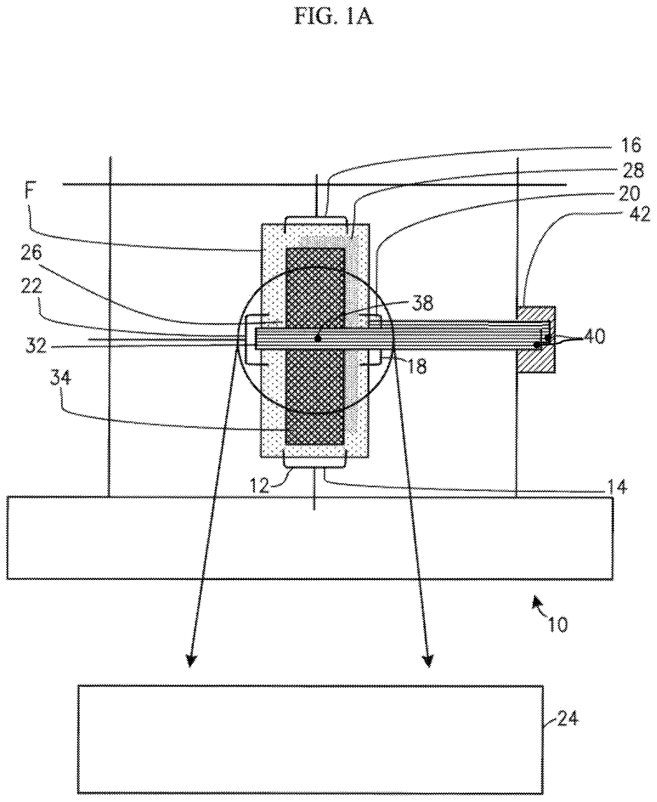

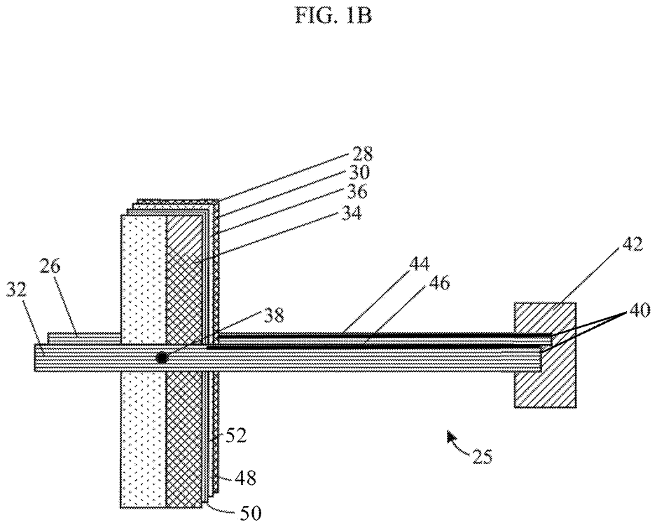

FIGS. 1-4C provide illustrative, non-exclusive examples of an apparatus and method for the in-situ EIS measurement of a polymeric film during biaxial stretching, according to the present disclosure, together with elements that may include, be associated with, be operatively attached to, and/or utilize such a method or system.

In FIGS. 1-4C, numerals denote like, or similar, structures and/or features; and each of the illustrated structures and/or features may not be discussed in detail herein with reference to the figures. Similarly, each structure and/or feature may not be explicitly labeled in the figures; and any structure and/or feature that is discussed herein with reference to the figures may be utilized with any other structure and/or feature without departing from the scope of the present disclosure.

In general, structures and/or features that are, or are likely to be, included in a given embodiment are indicated in solid lines in the figures, while optional structures and/or features are indicated in broken lines. However, a given embodiment is not required to include all structures and/or features that are illustrated in solid lines therein, and any suitable number of such structures and/or features may be omitted from a given embodiment without departing from the scope of the present disclosure.

Although the approach disclosed herein can be applied to a variety of apparatus designs and methods, the present description will primarily be directed to an apparatus and method for the in-situ EIS measurement of a polymeric film during biaxial stretching.

Referring now to FIG. 1A, an apparatus 10 for the in-situ measurement of a polymeric film F during biaxial stretching is depicted. As shown, apparatus 10 includes gripping means 12 for gripping and stretching the polymeric film in a first planar (y) direction. Gripping means 12 includes bottom vertical clamp 14 and top vertical clamp 16. Apparatus 10 also includes gripping means 18 for gripping and stretching the polymeric film in a second planar (x) direction. Gripping means 18 includes right horizontal clamp 20 and left horizontal clamp 22.

Apparatus 10 also includes an electrochemical impedance spectroscopic (EIS) system 24 for measuring the ionic conductivity of the polymeric film in both in-plane (x-y) and out-of-plane directions. EIS system 24 may also be called a potentiostat which is equipped with special hardware to apply and measure small amplitude alternating current (AC) signals across a wide range of frequencies, allowing for the analysis of polymeric film F's impedance characteristics at different frequencies; essentially, it is specialized potentiostat with EIS capabilities built in. EIS system 24 will be discussed more hereinbelow.

For automatic stretching, apparatus 10 may include a first motor (not shown) for stretching the polymeric film F in a first planar (y) direction. Apparatus 10 may also include a second motor (not shown) for stretching the polymeric film F in a second planar (x) direction. First and second motors may both be computer controlled.

Referring also to FIG. 1B, an out-of-plane view of the EIS setup 25, according to the present disclosure, is depicted. As shown, the dynamic apparatus 10 also includes a back horizontal supporting rod 26, the back horizontal supporting rod 26 affixed to a back vertical supporting rod 28 and a first blocking electrode 30 located at the back of the (x-y) plane.

Apparatus 10 also includes a front horizontal supporting rod 32, the front horizontal supporting rod 32 secured to a front vertical supporting rod 34 and a second blocking electrode 36 wherein the front horizontal supporting rod 32 faces the front vertical supporting rod across the polymer film F to enable out-of-plane in situ EIS measurements.

The apparatus 10 includes a first bolt 38 for securing the front horizontal supporting rod 32 to the front vertical supporting rod 34 and the second blocking electrode 36 and the back horizontal supporting rod 26, and a back vertical supporting rod 28 and the first blocking electrode 30. Apparatus 10 also includes a second bolt 40 for securing the front horizontal supporting rod 32 to the back horizontal supporting rod 26 and a vertical member 42.

Apparatus 10 also includes a first connector 44 for connecting the first blocking electrode 30 to the EIS system 24. A second connector 46 is employed for connecting the second blocking electrode 36 to the EIS system 24 and measuring the ionic conductivity of the polymeric film F in out-of-plane directions (z).

The first blocking electrode 30 of apparatus 10 has a first surface area 48, and the second blocking electrode 36 has second surface area 50, wherein the first surface area 48 and second surface area 50 are substantially equal. Optionally, a pressure sensor 52 to monitor surface pressure between the first blocking electrode 30 and second blocking electrode 36 while taking EIS measurements using EIS system 24. The pressure sensor may be a piezo film pressure sensor 52 or a torque-controlled screw (not shown).

In one aspect, this disclosure describes the capability for 3D in situ out-of-plane ion conductivity measurements of polymer films using Electrochemical Impedance Spectroscopy (EIS) coupled with biaxial stretching. FIG. 1A shows the arrangement of vertical and horizontal clamps for biaxial stretching combined with the out-of-plane EIS measurement setup. FIG. 1B provides a zoomed-out view of the out-of-plane EIS setup, with labels for the various components according to the present disclosure

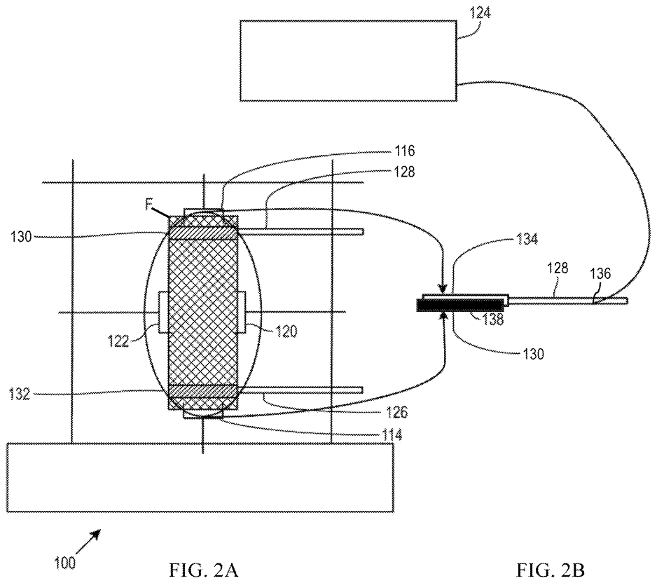

Referring now to FIGS. 2A and 2B, apparatus 100 enables 3D in situ in-plane ion conductivity measurements of polymer film F using an Electrochemical Impedance Spectroscopy (EIS) system 124. EIS system 124 is operatively connected to apparatus 100 for measurements to be taken during biaxial stretching of polymer film F.

FIG. 2A illustrates, for apparatus 100, the arrangement of vertical clamps 114 and 116 and horizontal clamps 120 and 122 for biaxial stretching combined with in-plane EIS measurement setup. The supporting horizontal rods 126 and 128 are integrated with the blocking electrodes 130 and 132 in the X-Y-plane

FIG. 2B shows an enlarged view of the in-plane EIS setup, with different elements labeled according to the present disclosure. As mentioned above, the supporting horizontal rods 126 and 128 are integrated with the blocking electrodes 130 and 132 in the X-Y-plane.

In enlarged FIG. 2B, for apparatus 100, all supporting rods and blocking electrodes are clearly labeled. The blocking electrode 130 features a conductive side 134 and an insulated side 138, connected to the horizontal rod 128 as depicted in the figure. Connector 136 schematically demonstrates the connection of the blocking electrodes 130 (and 132) to the EIS measurement system 124.

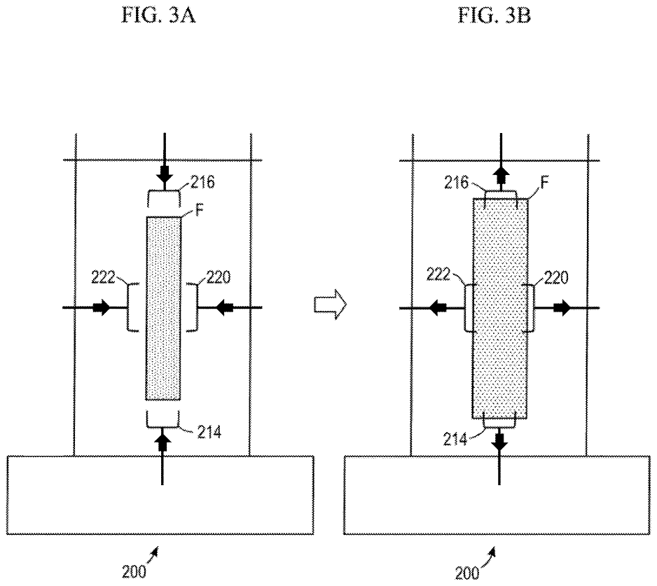

FIG. 3A presents a combined sectional view of simultaneous biaxial stretching. In this figure, the clamping position is shown, in accordance with an embodiment of the present disclosure. FIG. 3A illustrates, for apparatus 200, the arrangement of vertical clamps 214 and 216 and horizontal clamps 220 and 222 for biaxial stretching.

FIG. 3B depicts the polymer film in a simultaneously biaxially stretched condition, in accordance with an embodiment of the present disclosure. As in FIG. 3A, for apparatus 200, the arrangement of vertical clamps 214 and 216 and horizontal clamps 220 and 222 are depicted for biaxial stretching.

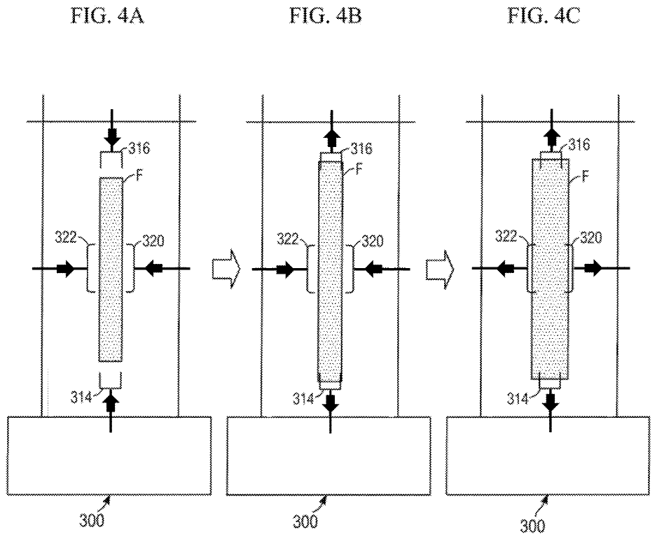

FIG. 4A presents a combined sectional view of sequential biaxial stretching. As shown, FIG. 4A illustrates the clamping position, in accordance with an embodiment of the present disclosure. FIG. 4A illustrates, for apparatus 300, the arrangement of vertical clamps 314 and 316 and horizontal clamps 320 and 322 for biaxial stretching.

FIG. 4B shows the vertically stretched condition and horizontal clamping position, in accordance with an embodiment of the present disclosure. FIG. 4B illustrates, for apparatus 300, the arrangement of vertical clamps 314 and 316 and horizontal clamps 320 and 322 for biaxial stretching.

FIG. 4C shows the polymer film in a sequentially stretched vertical and horizontal condition according to an embodiment of the present disclosure. FIG. 4C illustrates, for apparatus 300, the arrangement of vertical clamps 314 and 316 and horizontal clamps 320 and 322 for biaxial stretching.

Also provided herein is a method for the in-situ measurement of a polymeric film during biaxial stretching. The method includes gripping the polymeric film in a first planar (x) direction, gripping the polymeric film in a second planar (y) direction, stretching the polymeric film in a first planar (x) direction, stretching the polymeric film in a second planar (y) direction; and measuring ionic conductivity of the polymeric film in both an in-plane (x-y) direction and an out-of-plane direction using an electrochemical impedance spectroscopic (EIS) system.

In some embodiments, the dynamic method includes the step of stretching the polymeric film in the first planar (x) direction with a first motor.

In some embodiments, the dynamic includes the step of stretching the polymeric film in the second planar (y) direction with a second motor.

In some embodiments, the dynamic method includes the step of controlling the first motor and the second motor via a computer.

In some embodiments, the dynamic method includes the step of affixing a back horizontal supporting rod to a back vertical supporting rod and a first blocking electrode located at the back of the (x-y) plane.

In some embodiments, the dynamic method includes the step of affixing a front horizontal supporting rod to a front vertical supporting rod and a second blocking electrode wherein the front horizontal supporting rod faces the front vertical supporting rod across the polymer film to enable out-of-plane in situ EIS measurements.

In some embodiments, the dynamic method includes the step of securing with a first bolt the front horizontal supporting rod to the front vertical supporting rod and the second blocking electrode and the back horizontal supporting rod, and a back vertical supporting rod and the first blocking electrode.

In some embodiments, the dynamic method includes the step of securing with a second bolt the front horizontal supporting rod to the back horizontal supporting rod.

In some embodiments, the dynamic method includes the step of connecting the first blocking electrode to the EIS system using a first connector.

In some embodiments, the dynamic method includes the step of connecting the second blocking electrode to the EIS system using a second connector and measuring the ionic conductivity of the polymeric film in both in-plane (x-y) and out-of-plane directions.

EIS offers kinetic and mechanistic data of various electrochemical systems and is widely used in corrosion studies, semiconductor science, energy conversion and storage technologies, chemical sensing and biosensing, noninvasive diagnostics, etc. EIS is based on the perturbation of an electrochemical system in equilibrium or in steady state, via the application of a sinusoidal signal (ac voltage or ac current) over a wide range of frequencies and the monitoring of the sinusoidal response (current or voltage, respectively) of the system toward the applied perturbation. Considering that the electrochemical system under study is a linear time-invariant system (that is, the output signal is linearly related to the input signal and the behavior of the system is not changed over time), EIS is a “transfer function” technique that models the output signal (ac current or ac voltage) to the input signal (ac voltage or ac current) over a wide range of frequencies.

The importance of EIS over other electrochemical techniques lies in its ability to discriminate and, thus, to provide a wealth of information for various electrical, electrochemical, and physical processes that take place in a real electrochemical system. This task is particularly challenging as all these different processes exhibit different (from very fast to very slow) time behaviors. The resistance of a liquid electrolyte, the different bulk and grain boundary conductivities when a solid polycrystalline electrolyte is employed, the charging/discharging of the electric double layer at the electrolyte/electrolyte interface, the dependence of the capacitive behavior of the electric double layer on the morphology of the electrode surface and the composition of the electrolyte, the kinetics of an electrode charge-transfer reaction, homogeneous reactions and adsorption/desorption phenomena coupled with the electrode charge-transfer reaction, mass transfer phenomena (diffusion of species to the electrode surface), etc., exhibit different time constants, τ, (a measure of the time behavior of a process). The time constant of a process is given as τ=RC; where R is the resistance of a resistor in ohms and C is the capacitance of a capacitor in farad, F. Note that time constant is in time units in s. [(1 ohm)×(1 farad)=(1 V/1 A)×(1 coulomb/1 V)=1 coulomb/ampere=1 s].

Notably, EIS measurements at an electrochemical system can be simulated to an equivalent electrical circuit, which consists of common passive components (such as resistances, capacitors, and inductors) and others, more complicated (referred to as distributed) elements, connected each other in different ways. In other words, each of these processes can consequently be deemed analog to an equivalent electrical circuit that is characterized by a different time constant. For this purpose, most electrochemical analyzers are provided with suitable software enabling the simulation of the impedance data to a model circuit. Specialized equivalent circuit modeling software, such as Zview and Zplot (Scribner Associates, Inc.) is also available. A prerequisite for the simulation of the EIS data to an equivalent electric circuit is that the validity of the data has prior been evaluated. This can be done by running the so-called Kramers-Kronig test, which is available in most software provided with electrochemical analyzers.

When working in the time domain, as with one of the commonly used voltammetry techniques (cyclic voltammetry, a chrono technique, etc.), some of these processes is very difficult, if not impossible, to be analyzed. On the other hand, when working in the frequency domain, over a wide range of frequencies, EIS simplifies a complex electrochemical system by deconvoluting it in individual processes with different time constants, which then can be easily analyzed. Very slow processes can be probed in (very) low frequencies, while very fast processes can be probed at very high frequencies.

These unique capabilities have established EIS as a powerful and highly competitive technique for the study, optimization, and development of various real electrochemical cells in modern applications in corrosion science, fuel cells, lithium-ion batteries, photovoltaic cells, and biosensing. Simulated impedance plots for a rotating disk electrode experiment at different angular velocity values, of a reflective boundary element for increasing values of the diffusion related parameter, and of a C-E reaction at different reaction rate values are given. The impedimetric profile of a porous electrode with a transmission line is presented, while the inductive behavior in electrochemical cells and during impedance measurements, as well as additional practical considerations in conducting an EIS experiment are provided.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

Illustrative, non-exclusive examples of systems and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A1. A dynamic apparatus for the in-situ measurement of EIS of a polymeric film during biaxial stretching, comprising: a. gripping means for gripping and stretching the polymeric film in a first planar (y) direction; b. gripping means for gripping and stretching the polymeric film in a second planar (x) direction; and c. an electrochemical impedance spectroscopic (EIS) system for measuring ionic conductivity of the polymeric film in both in-plane (x-y) and out-of-plane directions.

A2. The dynamic apparatus of paragraph A1, further comprising a first motor for stretching the polymeric film in the first planar (y) direction

A3. The dynamic apparatus of paragraph A2, further comprising a second motor for stretching the polymeric film in the second planar (x) direction.

A4. The dynamic apparatus of paragraph A3, wherein the first motor and the second motor are each computer controlled.

A5. The dynamic apparatus of paragraph A1, further comprising a back horizontal supporting rod, the back horizontal supporting rod affixed to a back vertical supporting rod and a first blocking electrode located at the back of the (x-y) plane.

A6. The dynamic apparatus of paragraph A5, further comprising a front horizontal supporting rod, the front horizontal supporting rod secured to a front vertical supporting rod and a second blocking electrode wherein the front vertical supporting rod faces the back vertical supporting rod across the polymer film to enable out-of-plane in situ EIS measurements.

A7. The dynamic apparatus of paragraph A6, further comprising a first bolt for securing the front horizontal supporting rod to the front vertical supporting rod and the second blocking electrode and the back horizontal supporting rod, and a back vertical supporting rod and the first blocking electrode.

A8. The dynamic apparatus of paragraph A7, further comprising a second bolt for securing the front horizontal supporting rod to the back horizontal supporting rod.

A9. The dynamic apparatus of paragraph A8, further comprising a first connector for connecting the first blocking electrode to the EIS system.

A10. The dynamic apparatus of paragraph A9, further comprising a second connector for connecting the second blocking electrode to the EIS system and measuring the ionic conductivity of the polymeric film in both in-plane (x-y) and out-of-plane directions.

A11. The dynamic apparatus of paragraph A10, wherein the first blocking electrode has a first surface area, and the second blocking electrode has a second surface area wherein the first and second surface areas are substantially equal.

A12. The dynamic apparatus of paragraph A1, further comprising a pressure sensor to monitor surface pressure between the first and second blocking electrodes while taking EIS measurements.

A13. The dynamic apparatus of paragraph A12, wherein the pressure sensor is a piezo film pressure sensor or a torque-controlled screw.

B1. A dynamic method for the in-situ measurement of a polymeric film during biaxial stretching, comprising: gripping the polymeric film in a first planar (x) direction; gripping the polymeric film in a second planar (y) direction; stretching the polymeric film in a first planar (x) direction; stretching the polymeric film in a second planar (y) direction; and measuring ionic conductivity of the polymeric film in both an in-plane (x-y) direction and an out-of-plane direction using an electrochemical impedance spectroscopic (EIS) system.

B2. The dynamic method of paragraph B1, further comprising the step of stretching the polymeric film in the first planar (x) direction with a first motor.

B3. The dynamic method of paragraph B2, further comprising the step of stretching the polymeric film in the second planar (y) direction with a second motor.

B4.The dynamic method of paragraph B3, further comprising the step of controlling the first motor and the second motor via a computer.

B5. The dynamic method of paragraphs B1, further comprising the step of affixing a back horizontal supporting rod to a back vertical supporting rod and a first blocking electrode located at the back of the (x-y) plane.

B6.The dynamic method of paragraph B5, further comprising the step of affixing a front horizontal supporting rod to a front vertical supporting rod and a second blocking electrode wherein the back vertical supporting rod faces the front vertical supporting rod across the polymer film to enable out-of-plane in situ EIS measurements.

B7. The dynamic method of paragraph B6, further comprising the step of securing with a first bolt the front horizontal supporting rod to the front vertical supporting rod and the second blocking electrode and the back horizontal supporting rod, and a back vertical supporting rod and the first blocking electrode.

B8. The dynamic method of paragraph B7, further comprising the step of securing with a second bolt the front horizontal supporting rod to the back horizontal supporting rod.

B9. The dynamic method of paragraph B8, further comprising the step of connecting the first blocking electrode to the EIS system using a first connector.

B10. The dynamic method of paragraph B9, further comprising the step of connecting the second blocking electrode to the EIS system using a second connector and measuring the ionic conductivity of the polymeric film in both in-plane (x-y) and out-of-plane directions.

### INDUSTRIAL APPLICABILITY

The systems and methods disclosed herein are applicable to the polymer and testing industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and sub combinations of the various elements, features, functions, and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and sub-combinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A dynamic apparatus for the in-situ measurement of EIS of a polymeric film during biaxial stretching, comprising:
a. gripping means for gripping and stretching the polymeric film in a first planar (y) direction;
b. gripping means for gripping and stretching the polymeric film in a second planar (x) direction; and
c. an electrochemical impedance spectroscopic (EIS) system for measuring ionic conductivity of the polymeric film in both in-plane (x-y) and out-of-plane directions.

2. The dynamic apparatus of claim 1, further comprising a first motor for stretching the polymeric film in the first planar (y) direction and a second motor for stretching the polymeric film in the second planar (x) direction.

3. The dynamic apparatus of claim 2, wherein the first motor and the second motor are each computer controlled.

4. The dynamic apparatus of claim 1, further comprising a back horizontal supporting rod, the back horizontal supporting rod affixed to a back vertical supporting rod and a first blocking electrode located at the back of the (x-y) plane.

5. The dynamic apparatus of claim 4, further comprising a front horizontal supporting rod, the front horizontal supporting rod secured to a front vertical supporting rod and a second blocking electrode wherein the front vertical supporting rod faces the back vertical supporting rod across the polymer film to enable out-of-plane in situ EIS measurements.

6. The dynamic apparatus of claim 5, further comprising a first bolt for securing the front horizontal supporting rod to the front vertical supporting rod and the second blocking electrode and the back horizontal supporting rod, and a back vertical supporting rod and the first blocking electrode.

7. The dynamic apparatus of claim 6, further comprising a second bolt for securing the front horizontal supporting rod to the back horizontal supporting rod.

8. The dynamic apparatus of claim 7, further comprising a first connector for connecting the first blocking electrode to the EIS system and a second connector for connecting the second blocking electrode to the EIS system, and measuring the ionic conductivity of the polymeric film in both in-plane (x-y) and out-of-plane directions.

9. The dynamic apparatus of claim 8, wherein the first blocking electrode has a first surface area, and the second blocking electrode has a second surface area wherein the first and second surface areas are substantially equal.

10. The dynamic apparatus of claim 1, further comprising a pressure sensor to monitor surface pressure between the first and second blocking electrodes while taking EIS measurements.

11. The dynamic apparatus of claim 10, wherein the pressure sensor is a piezo film pressure sensor or a torque-controlled screw.

12. A dynamic method for the in-situ measurement of a polymeric film during biaxial stretching, comprising:
gripping the polymeric film in a first planar (x) direction;
gripping the polymeric film in a second planar (y) direction;
stretching the polymeric film in a first planar (x) direction;
stretching the polymeric film in a second planar (y) direction; and
measuring ionic conductivity of the polymeric film in both an in-plane (x-y) direction and an out-of-plane direction using an electrochemical impedance spectroscopic (EIS) system.

13. The dynamic method of claim 12, further comprising the step of stretching the polymeric film in the first planar (x) direction with a first motor.

14. The dynamic method of claim 13, further comprising the step of stretching the polymeric film in the second planar (y) direction with a second motor.

15. The dynamic method of claim 14, further comprising the step of controlling the first motor and the second motor via a computer.

16. The dynamic method of claim 12, further comprising the step of affixing a back horizontal supporting rod to a back vertical supporting rod and a first blocking electrode located at the back of the (x-y) plane.

17. The dynamic method of claim 16, further comprising the step of affixing a front horizontal supporting rod to a front vertical supporting rod and a second blocking electrode wherein the back vertical supporting rod faces the front vertical supporting rod across the polymer film to enable out-of-plane in situ EIS measurements.

18. The dynamic method of claim 17, further comprising the step of securing with a first bolt the front horizontal supporting rod to the front vertical supporting rod and the second blocking electrode and the back horizontal supporting rod, and a back vertical supporting rod and the first blocking electrode.

19. The dynamic method of claim 18, further comprising the step of securing with a second bolt the front horizontal supporting rod to the back horizontal supporting rod.

20. The dynamic method of claim 19, further comprising the step of connecting the first blocking electrode to the EIS system using a first connector and comprising the step of connecting the second blocking electrode to the EIS system using a second connector and measuring the ionic conductivity of the polymeric film in both in-plane (x-y) and out-of-plane directions.
